(19) United States
(12) Patent Application Publication
(10) Pub. No.: US 2015/0149638 A1
(43) Pub. Date: May 28, 2015

(54) Resource Allocation

(71) Applicant: Microsoft Corporation, Redmond, WA (US)

(72) Inventors: David Yuheng Zhao, Enebyberg (SE); Markus Vaalgamaa, Helsinki (FI); Mattias Nilsson, Sundbyberg (SE); Yariv Trablesi, Stockholm (SE)

(73) Assignee: Microsoft Corporation, Redmond, WA (US)

(21) Appl. No.: 14/194,287

(22) Filed: Feb. 28, 2014

(30) Foreign Application Priority Data
Nov. 22, 2013 (GB) 1320667.7

(51) Int. Cl. H04L 12/917

(52) U.S. Cl. CPC H04L 47/76
USPC 709/226

(57) ABSTRACT

There is disclosed a resource allocation module configured to: allocate a first set of communication event resources for receiving communication event data at the computer device; allocate a second set of communication event resources for transmitting communication event data from the computer device; and reallocate resources from one of said sets to the other of said sets in dependence on an indication of the relative importance of the received communication event data compared to the transmitted communication event data. There is also provided a method and a computer program product.

### RELATED APPLICATIONS

This application claims priority under 35 USC §119 or §365 to Great Britain Patent Application No. 1320667.7 entitled “Resource Allocation” filed Nov. 22, 2013 by Zhao et al., the disclosure of which is incorporate in its entirety.

### BACKGROUND

There exist communication systems that allow the user of a device, such as a personal computer or mobile device, to conduct voice or video calls over a packet-based computer network such as the Internet using various applications. Such communication systems include voice or video over Internet Protocol (VoIP) systems. These systems are beneficial to the user as they are often of significantly lower cost than conventional fixed line or mobile cellular networks. This may particularly be the case for long-distance communication. To use a VoIP system, the user installs and executes client software on their user device. The client software sets up the VoIP connections as well as providing other functions such as registration and authentication. In addition to voice communication, the client may also set up connections for other communication media such as instant messaging (“IM”), SMS messaging, file transfer and voicemail. All of these communications utilise the exchange of communication event data for effecting communication. Communication event data may include at least one of audio data, video data and information related to the content of a communication event (such as a video or audio call).

During a real time communication of event, resources in the user device are allocated for handling the communication event, for example, processing and memory resources for handling incoming and outgoing data and managing a network interface of the user device. Where the communication event is two way, resources are required for receiving data from another user device through the network (receiving downlink data) and for transmitting data to the other user device through the network (transmitting uplink data). Each user device has constrained resources, which may be required for other activities, as well as managing the communication event. A resource manager allocates resources to receiving downlink communication event data and to transmitting uplink communication event data. The resources could be processing resources of the user equipment, network bandwidth and/or any other resource for handling communication event data in the user equipment.

### SUMMARY

According to a first aspect, there is provided a resource allocation module configured to: allocate a first set of communication event resources for receiving communication event data at a computer device; allocate a second set of communication event resources for transmitting communication event data from the computer device; and reallocate resources from one of said sets to the other of said sets in dependence on an indication of the relative importance of the received communication event data compared to the transmitted communication event data. The computer device can be a user device and/or a device implemented in a network.

According to another aspect described herein, there is provided a method implemented by an application executed on a device, the method comprising the operations of: allocating a first set of communication event resources for receiving communication event data at a computer device; allocating a second set of communication event resources for transmitting communication event data from the computer device; and reallocating resources from one of said sets to the other of said sets in dependence on an indication of the relative importance of the received communication event data compared to the transmitted communication event data.

According to another aspect described herein, there is provided a computer program product, the computer program product being embodied on a computer readable medium and configured so as when executed on a processor of a device comprising a network interface to: allocate a first set of communication event resources for receiving communication event data at the computer device; allocate a second set of communication event resources for transmitting communication event data from the computer device; and reallocate resources from one of said sets to the other of said sets in dependence on an indication of the relative importance of the received communication event data compared to the transmitted communication event data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### FIGURES

For an understanding of the following and to show how the same may be put into effect, reference will now be made, by way of example, to the following drawings, in which:

FIG. 1 shows a schematic illustration of a communication system;

FIG. 2 is a schematic block diagram of a user device;

FIGS. 3A and 3B show illustrations of communication streams on user devices;

FIG. 4 shows a possible process; and

FIG. 5 shows a schematic illustration of a communication system.

### DETAILED DESCRIPTION

Embodiments will now be described by way of example only.

In an audio or video call the quality of different incoming audio and video streams can be of different importance to different users. An example is when a business user is talking to his customer. The perceived quality for the customer is of higher value than the perceived quality for the business user. Another example is when a speaker is giving a presentation in a multi-party call. The video and/or audio quality from the speaker may be more important than the video and/or audio quality from the mainly “listening-only” participants.

Thus, in order to maximize the user's opinion score (which is a metric indicative of the quality experienced by the user), the system resources such as CPU, bandwidth, etc. can be unequally distributed between the incoming streams. For instance, the incoming stream from the most active participant in a multiparty call may get more resources compared to the stream from the least active participant. Another example is to assign more resources to a stream that is actively picked by the user. Another example is for one user to configure his client in a way that outgoing quality is optimized more than incoming streams. The following is focussed on configuring one-to-one and multiparty audio and video calls in such an asymmetric fashion.

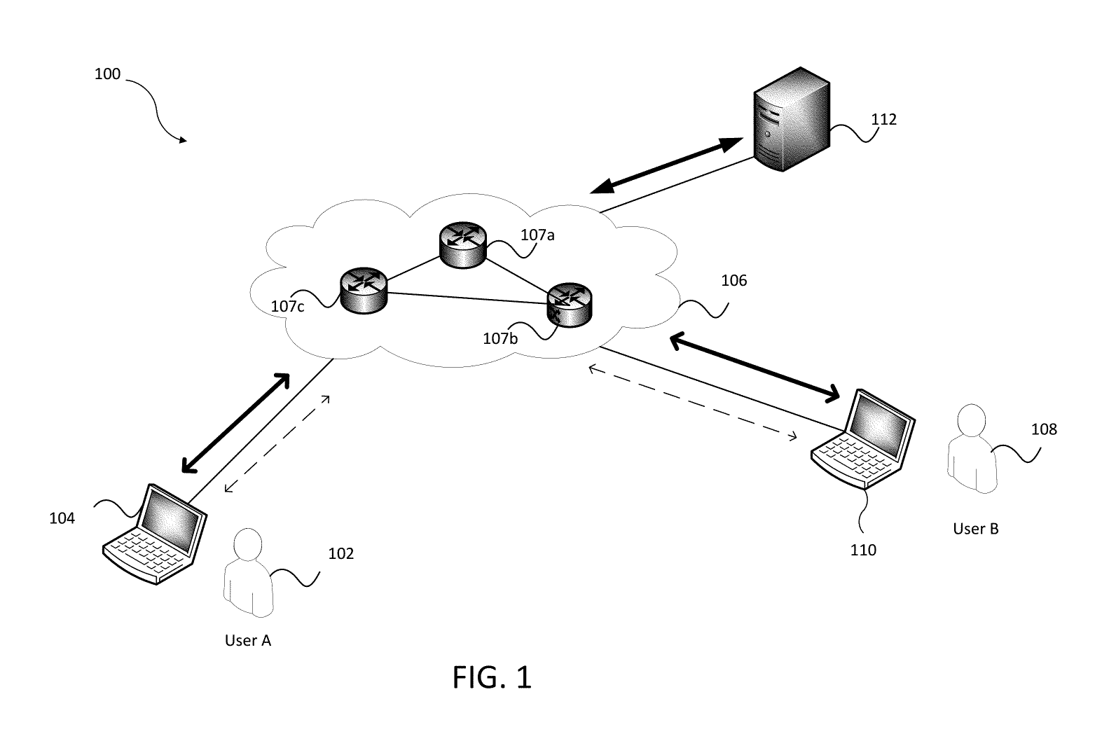

Consider in FIG. 1 a business user A speaking to his customer B. User A has a powerful computer and can handle very high resolutions. User B has a very slow computer and can handle either 1) sending and receiving video of resolution 320×240 or 2) sending video of resolution 160×120 and receiving 640×480. A typical solution may be to optimize for symmetry (i.e. option 1 is selected). However, the business user might want to optimize the customer's experience over his own, and instead opt for option 2. In this case, a button, or a configuration option, may be presented to at least one of the users so that an asymmetric quality distribution may be forced by an asymmetric allocation of resources.

FIG. 1 shows a communication system 100 comprising a first user 102 (“User A”) who is associated with a first user device 104 and a second user 108 (“User B”) who is associated with a second user device 110. In other embodiments the communication system 100 may comprise any number of users and associated user devices. The user devices 104 and 110 can communicate over a network 106 in the communication system 100, thereby allowing the users 102 and 108 to communicate with each other over the network 106. The communications between users 102 and 108 is represented by the dashed lines in FIG. 1. The network 106 may comprise one or more routing nodes 107 for relaying data between endpoints.

The communication system 100 shown in FIG. 1 is a packet-based communication system, but other types of communication system could be used. The network 106 may, for example, be the Internet. Each of the user devices 104 and 110 may be, for example, a mobile phone, a tablet, a laptop, a personal computer (“PC”) (including, for example, Windows®, Mac OS® and Linux® PCs), a gaming device, a television, a personal digital assistant (“PDA”) or other embedded device able to connect to the network 106. The user device 104 is arranged to receive information from and output information to the user 102 of the user device 104. The user device 104 comprises output means such as a display and speakers. The user device 104 also comprises input means such as a keypad, a touch-screen, a microphone for receiving audio signals and/or a camera for capturing images of a video signal. The user device 104 is connected to the network 106.

The user device 104 executes an instance of a communication client, provided by a software provider associated with the communication system 100. The communication client is a software program executed on a local processor in the user device 104. The client performs the processing required at the user device 104 in order for the user device 104 to transmit and receive data over the communication system 100.

The user device 110 also executes, on a local processor, a communication client which corresponds to the communication client executed at the user device 104. The client at the user device 110 performs the processing required to allow the user 108 to communicate over the network 106 in the same way that the client at the user device 104 performs the processing required to allow the user 102 to communicate over the network 106. The user devices 104 and 110 are endpoints in the communication system 100. FIG. 1 shows only two users (102 and 108) and two user devices (104 and 110) for clarity, but many more users and user devices may be included in the communication system 100, and may communicate over the communication system 100 using respective communication clients executed on the respective user devices.

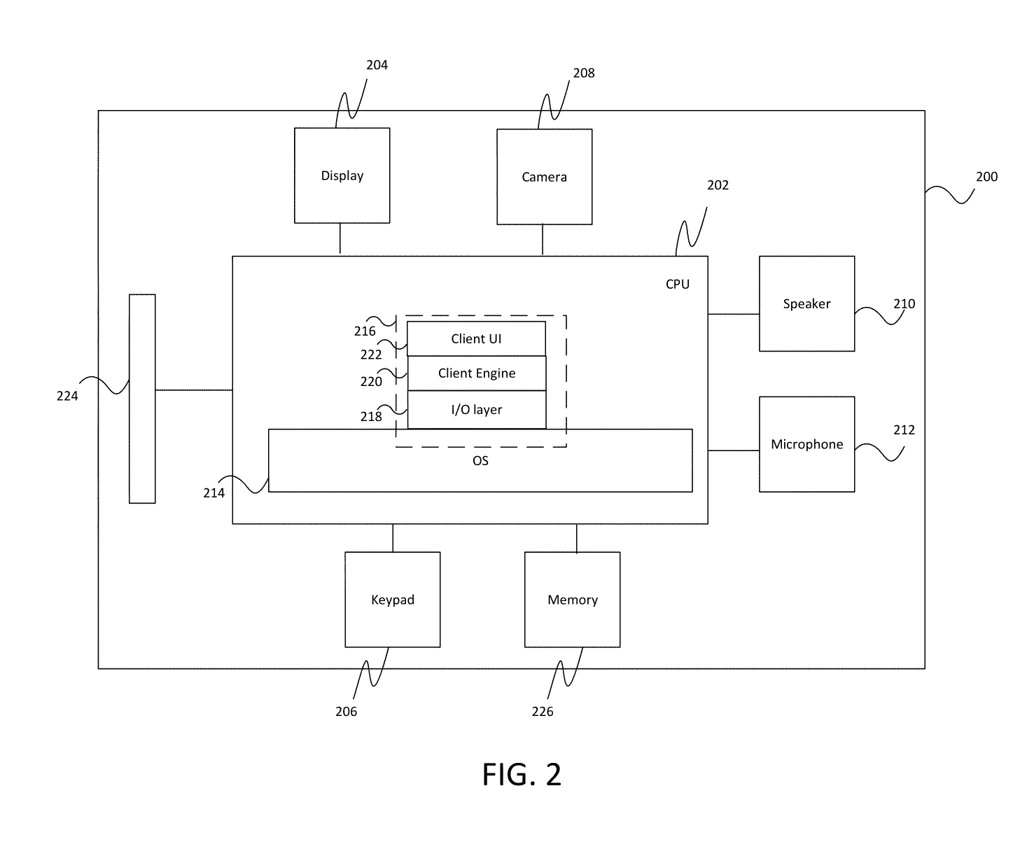

FIG. 2 illustrates a detailed view of the user terminal 200 on which is executed a communication application.

As mentioned above, the user terminal 200 may be, for example, a mobile phone, a tablet, a personal digital assistant (“PDA”), a personal computer (“PC”) (including, for example, Windows™, Mac OS™ and Linux™ PCs), a gaming device or other embedded device able to connect to the network 100 via the network controller 108. The user terminal 200 is arranged to receive information from and output information to a user of the user terminal 200.

The user terminal 200 comprises a central processing unit (“CPU”) 202, to which is connected a display 204 such as a screen or touch screen, input devices such as a keypad 206 and a camera 208. An output audio device 210 (e.g. a speaker) and an input audio device 212 (e.g. a microphone) are connected to the CPU 202. The display 204, keypad 206, camera 208, output audio device 210 and input audio device 212 may be integrated into the user terminal 200 as shown in FIG. 2. In alternative user terminals one or more of the display 204, the keypad 206, the camera 208, the output audio device 210 and the input audio device 212 may not be integrated into the user terminal 200 and may be connected to the CPU 202 via respective interfaces. One example of such an interface is a USB interface. The CPU 202 is connected to a network interface 224 for communication with a packet based network. The network interface 224 may be integrated into the user terminal 200 as shown in FIG. 2. In alternative user terminals the network interface 224 is not integrated into the user device 200. The user terminal 200 also comprises a memory 226 for storing data as is known in the art. The memory 226 may be a permanent memory, such as ROM. The memory 226 may alternatively be a temporary memory, such as RAM.

FIG. 2 also illustrates an operating system (“OS”) 214 executed on the CPU 202. Running on top of the OS 214 is a software stack 216 for the communication client application referred to above. The software stack shows an I/O layer 218, a client engine layer 220 and a client user interface layer (“UI”) 222. Each layer is responsible for specific functions. Because each layer usually communicates with two other layers, they are regarded as being arranged in a stack as shown in FIG. 2. The operating system 214 manages the hardware resources of the computer and handles data being transmitted to and from the network 106 via the network interface 224. The I/O layer 218 comprises audio and/or video codecs which receive incoming encoded streams and decodes them for output to speaker 210 and/or display 204 as appropriate, and which receive un-encoded audio and/or video data from the microphone 212 and/or camera 208 and encodes them for transmission as streams to other end-user terminals of the communication system 10. The client engine layer 220 handles the connection management functions of the VoIP system as discussed above, such as establishing calls or other connections by server-based or P2P address look-up and authentication. The client engine may also be responsible for other secondary functions not discussed herein. The client engine layer 220 also communicates with the client user interface layer 222. The client engine layer 220 may be arranged to control the client user interface layer 222 to present information to the user of the user terminal 200 via the user interface of the client which is displayed on the display 204 and to receive information from the user the user terminal 200 via the user interface.

The rate at which data can be transmitted over the network 100 from a user device is limited by the uplink bandwidth available to the user device. Similarly, the rate at which data can be transmitted over the network 100 to a user device is limited by the downlink bandwidth available to the user device. The present disclosure considers a reallocation between uplink and downlink bandwidth as described in the following. The uplink bandwidth of a user device is the range of frequencies over which the user device is currently configured to transmit event data. The downlink bandwidth of a user device is the range of frequencies over which the user device is currently configured to receive event data.

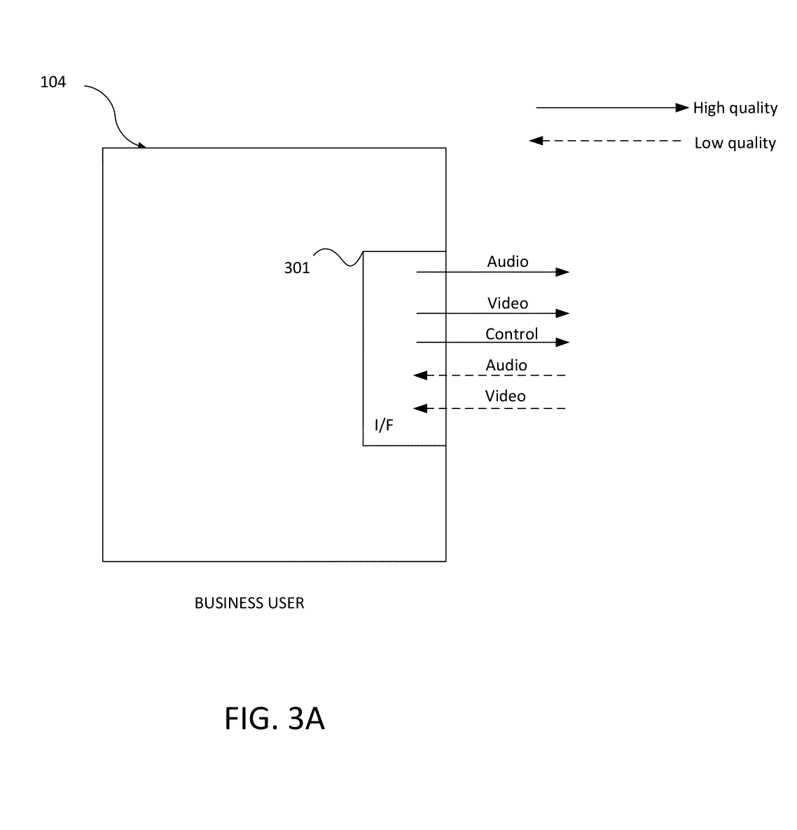

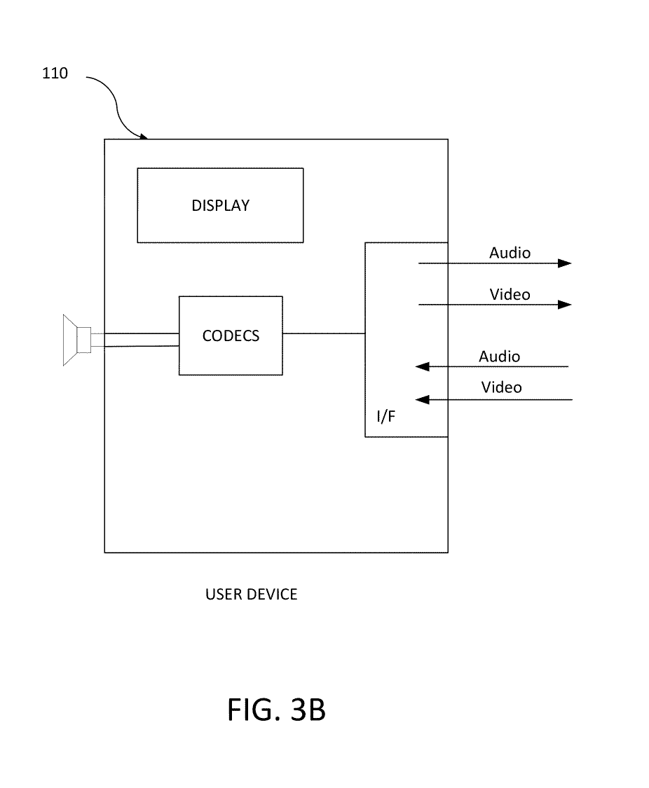

FIG. 3A depicts an example in which a business user 102 of a user device 104 configures a user device 110 of a client 108 to set the outgoing video and audio quality to be at a higher quality than the incoming video and audio quality. In particular, a communication module 301 in the user device 104 of the business user 102 transmits a control signal to the user device 110 of the client 108. The control signal comprises an indication that instructs the user device how to change the resource allocation. In FIG. 3A, the uplink audio and video data and the control signal transmitted by the user device 104 are at a higher quality than the received audio and video data from the user device 110 of the client 108. It is understood that the resources allocated to the audio data of a video call may be independently allocable to the video data of a video call.

The user device 110 of the client 108 is depicted in FIG. 3B. Therein, the user device 110 is configured to adjust the quality of audio and/or video data. For example, the user device 110 may be configured to prioritise the received audio data over the received video data by, for example, devoting more computing resources to processing the audio data and playing it through the loudspeaker than to processing the video data and rendering it to the display. Alternatively, the user device 110 may be configured to prioritise the received video data over the received audio data by, for example, devoting more computing resources in the user device to rendering the video data to the display than to playing the audio data through the loudspeaker.

The user device 110 may also be configured to allocate computing resources in dependence on indications so as to prioritise the presentation of information to a user 108 of the user device 110 (for example, audio data from a microphone and video data from a camera) relative to information collected from the user 108 (for example, audio data presented via the loudspeaker and video data presented via a display screen). The reverse configuration (i.e. prioritising collection of information over the presentation of information) is also possible.

The logic for resource allocation can be located in the client engine layer 220 of the allocating user device (e.g. in user device 110 in the present embodiment). However, in some embodiments (discussed later), a server located in a network 106 or router 107 may comprise the logic for resource allocation.

The user device may determine to make such an adjustment following the receipt of a direct or indirect indication from the client 108 of the user device 110 of a relative prioritisation of audio to video data. In other words, the user device may determine how to reallocate resources (such as computing resources) based on an indication of the relative priority of the uplink and downlink data channels. The user device may determine how to make such an adjustment following the receipt of an indication in a control signal received from another device, such as the control signal transmitted by the user device 104 in FIG. 3A.

Commonly, a user device has a certain number of resources, such as processing resources, allocated bandwidth, etc. In this context, allocated bandwidth can be bandwidth allocated by an external resource, such as a WiFi network or WLAN. Some of these resources may be allocated for effecting the communication of communication event data for video and/or audio calls. Commonly, these communication resources are allocated by the user device to uplink communications with at least one other user device and to downlink communications with the at least one other user device to achieve equal quality outcomes in the up and down links (option (1) discussed earlier). The following discloses embodiments in which the number of resources assigned for uplink communications is different to the number of resources assigned for downlink communications. The asymmetric resource allocation is determined in dependence on an indication of the relative importance of the uplink and downlink communication paths to at least one user of one or more of the user devices. When an indication is received from multiple user devices/multiple users, the indications may be aggregated to form a single indication for determining how resources may be reallocated in at least one of those devices.

All of the following embodiments are arranged so that an indication provided by a user and/or a user device on the relative importance of an uplink compared to a downlink for the user can be used to influence the ratio of allocated uplink to downlink resources to achieve different (asymmetric) quality outcomes. The indication may be implicit or explicit. This allows for link quality in a particular direction to be improved, which increases the quality of communications for a designated user.

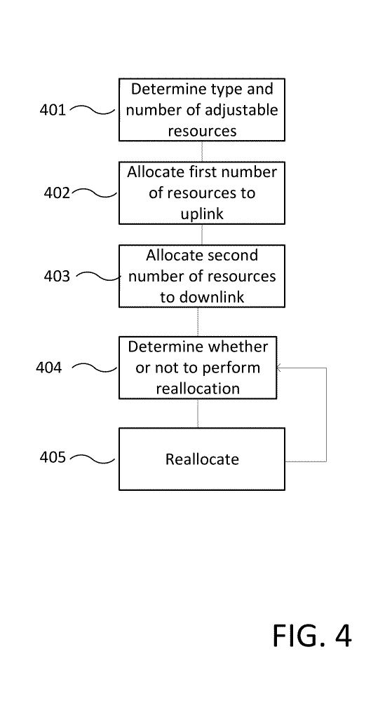

In a first embodiment, illustrated with reference to FIG. 4, there is a first user device 104 configured to communicate with only a second user device 110 through a network (as shown in FIG. 1). The first user device 104 is configured to perform the process operations of FIG. 4.

At 401, the first user device 104 is configured to determine the type and number of adjustable resources it has available for handling communication event data. In this context, “handling” includes at least those resources for receiving communication event data, transmitting communication event data, processing communication event data and presenting communication event data to a user of the first user device 104. In this context, “adjustable resources” means those resources over which the first user device 104 has control to reallocate.

At 402, the first user device 104 is configured to allocate a first number of resources to uplink communication event data transmissions to the second user device 110. This allocation may be made using a default allocation mechanism, such as allocating half the number of available resources to the uplink communication event data transmissions. Alternatively, this allocation may be made using information on the current or recent state of the uplink conditions (such as interference).

At 403, the first user device 104 is configured to allocate a second number of resources to downlink communication event data transmissions from the second user device 110. This allocation may be made using a default allocation mechanism or using information about the downlink conditions, as described above in relation to operation 402.

At 404, the first user is configured to determine whether or not to reallocate the currently allocated resources. This may be determined separately in respect of each type of resource or a single decision may be made that applies to every type of resource. The determination can be based on a plurality of criteria, all of which indicate the relative importance placed by a user on particular streams of communication event data on the uplink and the downlink.

One criterion is that an indication has been received from the second user device 110 indicating that more resources are to be provided to the uplink than the downlink (or vice versa). This indication could be based on an explicit user instruction to the second user device 110 instructing the reallocation of resources of the first user device 104 in a specified way. This indication could be based on implicit information on the relative importance between the uplink and downlink streams of communication event data. For example, implicit information could encompass whether more audio information is currently being detected in the uplink or the downlink direction, whether any windows through which image data from the communication event data is being displayed to a user have been minimised or otherwise covered up and whether the user of the second device is currently detected in the field of view of a camera of the device.

Another criterion is an indication provided by the first user device 104. Like the indication received from the second user device 110, this indication could be based on implicit information and/or an explicit instruction from the user of the first user device 104 to reallocate resources currently allocated to the uplink communication event data to downlink communication event data (or vice versa).

If it is determined that the resources are not to be reallocated, operation 404 is repeated at a later time.

If it is determined that the resources are to be reallocated, operation 405 is performed, in which the resources are reallocated between the uplink and the downlink in dependence on the result of the determination operation. The first user device 104 may be configured to, at any one time, reallocate the uplink/downlink resource ratio of only one type of resource between the uplink and downlink communication event data. Alternatively, the first user device 104 may be configured to reallocate the uplink/downlink resource ratios of multiple types of resources between the uplink and the downlink communication event data. The first user device 104 could be configured to determine which, and how many, resources to reallocate.

Operations 404 to 405 are subsequently repeated until the call ends.

The embodiment described in relation to FIG. 4 is particularly useful for cases in which a business user B of the first second device is talking to his customer A, who is the user associated with the first user device 104 using a video chat client. We assume that the first user device 104 is a very slow device and is capable of sending and receiving video of resolution 320×240 or of sending video with a resolution of 160×120 and receiving with a resolution 640×480. In prior art systems, the first user device 104 is configured to optimise for symmetry and opts for the equal sending and receiving resolutions. However, the business user B might want to optimise his customer's experience over his own and so prefer to configure the first user device 104 to send video with a resolution of 160×120 whilst receiving with a resolution of 640×480. In other words, the business user B places a higher relative importance on communication event data received by the first user device 104 than on communication event data transmitted by the first user device 104. In this case, the business user B of the second user 108 inputs an explicit instruction to the second user device 110 using, for example, a button provided on the screen of the second user device 110. This instruction is transmitted to the first user device 104, in the communication event for example, which determines whether or not to reconfigure its resources in dependence on this instruction.

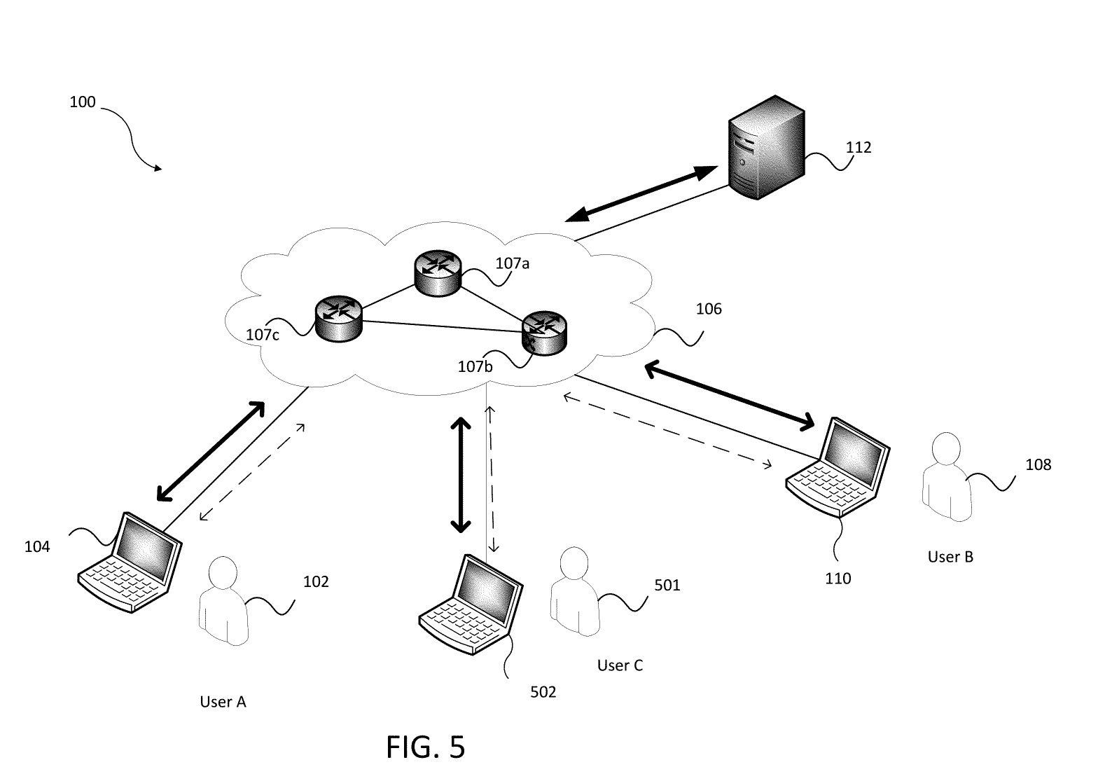

The principle outlined above in relation to FIG. 4 may be extended to those cases in which there are multiple user devices, each being associated with a particular user. This is illustrated in FIG. 5, in which three user devices are illustrated. It is understood that although only three user devices are illustrated, any number of user devices could be provided.

FIG. 5 is identical to FIG. 1, bar it additionally includes a third user 501, User C, associated with a third user device 502 for communicating with the first and second users 102, 108 through the network 106 and the first and second user devices 104, 110, for example, in a multiparty call.

In this embodiment, the first user device 104 is configured to execute the same process operations described above in relation to FIG. 4, bar account is also taken of any information provided by the third user 501 (User C) associated with the third user device. This information from the third user device may be used at the same time as when using information received from the second user 108 and/or the second user device 110, and/or at different times.

In the above described embodiments, multiple user devices are described as providing a relative indication of the importance of the uplink and downlink resources. If multiple indications are received from different user devices, the first user device 104 is configured to determine how to select to reallocate resources between the uplink and downlink in dependence on these multiple indications. This may include weighting the indications in dependence on where it comes from. In this way, indications from, for example, a call moderator, may affect the determination of how to reallocate resources more than indications received from regular users. The call moderator may be determined at set-up.

The principles described above may also be extended to the case where the reallocation of resources is performed by a central reallocation unit. In a first embodiment, the central reallocation unit may be based in network 106 and/or routing node 107 in FIGS. 1 and 5. In this case, information regarding the allocation of resources (and/or the relative importance of the user devices being considered), is provided to the central allocation unit. The central reallocation unit utilises the provided information to reallocate the system resources. The central reallocation unit may be implemented in a server in network 106 and/or routing node 107. To facilitate asymmetric reallocation of resources, information from all of the participants may be aggregated.

In the above described embodiments, explicit user instructions are described. To assist a user in determining whether or not to optimise an uplink over a downlink or vice versa, the user may be provided with an indication of the quality of communications received over the uplink and an indication of the quality of communications received over the downlink for the uplink and the downlink to be optimised. These quality indications can be presented to the user via a display screen of the user device.

The methods described above can be implemented in software (e.g. in the clients described above), or in hardware. More precisely, the methods described above can be implemented in a computer program product comprising computer readable instructions for execution by computer processing means (e.g. a CPU) at a node of the communication system (e.g. the user terminal 104 or the user terminal 110).

In all of the above described embodiments, the resources of the first user equipment may be at least one of: processing resources of the first user device; network bandwidth; and any other resource for handling communication event data in the user equipment.

In all of the above described embodiments, the ratio of the resources of a first user device allocated to an uplink to the resources of the first user device allocated to a downlink is varied in dependence on an indication from at least one user device of the relative importance of at least one data stream on the uplink or downlink. This reallocation can be performed periodically or aperiodically. The reallocation may be triggered to start only when an explicit instruction from a user of a user device participating in the call has been received. The explicit instruction could indicate to the device that determines the reallocation (i.e. either the first user equipment or the central allocation unit) how the resource indication may be changed. Alternatively, the explicit instruction could simply indicate to the device that determines the reallocation that a determination is requested. The reallocation determining device may then retrieve information indicative of the relative importance of the uplink communication event data to the downlink communication event data for making this determination. The determination may also be performed, on occasion, without any explicit user input or instruction (e.g. as in the case of the implicit indication described in relation to FIG. 4). The implicit determinations are advantageously made periodically whilst the explicit user instruction is advantageously received aperiodically.

As mentioned above, the quality of a stream of communication data may by modified by modifying at least one of: the frame-rate, the resolution and the source coding quality of the stream. The modification may be made so as to prioritise at least one stream of communication event data transmitted or received by a device over other streams of communication event data transmitted or received by that device.

It will be appreciated that in the example described above the first user device 104 may require a larger share of the total available bandwidth than the second user device 110 and/or the third user device 502 (i.e. may need to transmit and/or receive data at a higher rate) based on the types of activity performed by the first user device 104.

In other implementations, the resource reallocation unit (embodied in either a user device or in a network entity upstream of a user device) may determine the data rate limits (and thus the bandwidth allocations) for each of the plurality of user devices based on the user devices' level of demand for bandwidth.

For example, when the request for bandwidth received from each of the plurality of users comprises an indication of the activity to be handled (for example, a voice call, a video call, a file transfer etc.) in addition to an indication that bandwidth is required, the resource reallocation unit (embodied in either a user device or in a network entity upstream of a user device) is able to determine using suitable processing logic the data rate (and thus the bandwidth to provide the determined data rate) required for the particular activity. The resource reallocation unit may be configured with upload and/or download rates required for certain activities, and thus be able to determine an appropriate uplink and/or downlink data rate limit (and thus an appropriate upload and/or download bandwidth) based on detecting the activity to be performed by the application. The resource reallocation unit is able to obtain a global view of the demand for bandwidth from each of a plurality of applications requiring usage of the total available bandwidth and determine a bandwidth allocation for each of the plurality of applications accordingly.

The resource reallocation unit is also able to obtain the global view of the demand for bandwidth from each of a plurality of applications requiring usage of the total available bandwidth when the request for bandwidth from each application comprises an indication of a required upload and/or download data rate (i.e. connection speed). Thus, the resource reallocation unit is able to determine a bandwidth allocation for each of the plurality of applications based on the required upload and/or download data rates.

The inventors have recognised that such a symmetric allocation is not always desirable, depending on the type of relationship and the type of communication between the different users. The inventors have therefore proposed a mechanism for reallocating resources for communication event data.

References in the above to a bandwidth may include references to a frequency (Hz), a connection speed (data rate in bps) and to both.

Modern audio and video processing components (such as encoders, decoders, echo canceller, noise reducers, anti-aliasing filters etc.) can typically achieve higher output audio/video quality by employing more complex audio/video algorithmic processing operations. These operations are typically implemented by one or more software applications executed by a processor (e.g. CPU) of a computing system. The application(s) may comprise multiple code components (for instance, separate audio and video processing components), each implementing separate processing algorithms Processor resource management in the present context pertains to adapting the complexity of such algorithms to the processing capabilities of such a processor. As used herein “complexity” of a code component implementing an algorithm refers to a temporal algorithmic complexity of the underlying algorithm. As is known in the art, the temporal complexity of an algorithm is an intrinsic property of that algorithm which determines a number of elementary operations required for that algorithm to process any given input, with more complex algorithms requiring more elementary processing operations per input than their less sophisticated counterparts. As such, this improved quality comes at a cost as the more complex, higher-quality algorithms either require more time to process each input, or they require more processor resources, and thus result in higher CPU loads, if they are to process input data at a rate which is comparable to less-complex, lower-quality processing algorithms.

For “real-time” data processing, such as processing of audio/video data in the context of audio/video conferencing implemented by real-time audio/video code components of a communication client application, quality of output is not the only consideration: it is also strictly necessary that these algorithmic operations finish in “real-time”. As used herein, in general terms, “real-time” data processing means processing of a stream of input data at a rate which is at least as fast as an input rate at which the input data is received (i.e. such that if N bits are received in a millisecond, processing of these N bits must take no longer than one millisecond); “real-time operation” refers to processing operations meeting this criteria. As such, allowing the more complex algorithms more processing time is not an option as the algorithm has only a limited window in which to process N bits of the stream, that window running from the time at which the N bits are received and the time at which the next N bits in the stream are received—the algorithmic operations needed to process the N bits all have to be performed within this window and cannot be deferred if real-time operation is to be maintained. Therefore more processor resources are required by a code component as its complexity increases if it is to maintain real-time operation. Further, if CPU load is increased beyond a certain point—for instance, by running unduly complex audio/video processing algorithms—then real-time operation will simply not be possible as the audio and/or video components would, in order to operate in real-time, require more processor resources than are actually available. Thus, there is a trade-off between maximising output quality on the one hand whilst preserving real-time operation on the other.

In the context of audio/video processing specifically, raw audio and video data is processed in portions, which are then packetized for transmission. Each audio data portion may be (e.g.) an audio frame of 20 ms of audio; each video data portion may be (e.g.) a video frame comprising an individual captured image in a sequence of captured images. In order to maintain real-time operation, processing of an audio frame finalizes before capture of the next audio frame is completed; otherwise, subsequent audio frames will be buffered and an increasing delay is introduced in the computing system. Likewise, processing of a video frame should finalize before the next video frame is captured for the same reason. For unduly complex audio/video algorithms, the processor may have insufficient resources to achieve this.

The resources of a particular user device 104, 110, 502 may be embodied in hardware or software. Examples include sampling rate of received data, processor resources for executing code (e.g. number of cycles and/or operating processor clock speed in a particular time period) assigned to audio and/or video data and any other resources assigned for presenting audio and/or video information to a user.

Processor resources may be reallocated by adjusting a number of low-level machine-code instructions needed to implement processing functions such as audio or video processing (as less complex algorithms are realized using fewer machine-code instructions). Processor resources may also be reallocated using a low-level thread scheduler, which allocates resources to different threads by selectively delaying execution of thread instructions relative one another.

Although the above describes the reallocation of resources in relation to video calls comprising both a video and an audio component, it is understood that the same principles may apply to audio only data streams or video only data streams.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU, CPUs, or DSP). The program code can be stored in one or more computer readable memory devices. The features of the techniques described below are platform-independent, meaning that the techniques may be implemented on a variety of commercial computing platforms having a variety of processors.

For example, the user terminals may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A resource allocation module configured to:
allocate a first set of communication event resources for receiving communication event data at a computer device;
allocate a second set of communication event resources for transmitting communication event data from the computer device; and
reallocate resources from one of said sets to the other of said sets in dependence on an indication of the relative importance of the received communication event data compared to the transmitted communication event data.

2. A resource allocation module according to claim 1, further configured to:
receive said indication from at least one remote user equipment, said indication being an instruction to transfer resources from one of said sets to the other of said sets.

3. A resource allocation module according claim 1, further configured to:
determine an indication of the relative importance of the received communication event data compared to the transmitted communication event data;
wherein the reallocating is performed in dependence on the determined indication.

4. A resource allocation module according to claim 3 wherein the indication is determined in dependence on at least one of: an explicit indication provided by a user of the computer device; and an implicit indication from the user.

5. A resource allocation module according to claim 4 wherein the implicit indication is at least one of: detection of speech by the user; how the received communication event data is presented to a user; and detection of speech in the received communication event data.

6. A resource allocation module according to claim 1, wherein the first and second resources are equal prior to the reallocating.

7. A resource allocation unit according to claim 1, comprising a network element configured to transfer information between the computer device and at least one remote user equipment.

8. A resource allocation unit according to claim 1, wherein the resources are at least one of: a bandwidth; processing resources in the computer device; frame rate; and resolution of transmitted data.

9. A resource allocation unit according to claim 1, further configured to reallocate resources from one of said sets to the other said sets so as to improve a quality of at least one stream of communication event data relative to other streams of communication event data, the streams of communication event data being either transmitted or received by the computer device.

10. A resource allocation unit according to claim 1, wherein the resource allocation module is configured to prioritise one of video and audio communication event data relative to each other and to reallocate resources from one of said sets to the other said sets so as to improve the prioritised communication event data.

11. A resource allocation unit according to claim 1, further comprising:
a receive module for receiving communication event data from at least one remote user equipment; and
a transmit module for transmitting communication event data to the at least one remote user equipment.

12. A resource allocation unit according to claim 1, wherein the resource allocation module is configured to allocate the second set of communication event resources prior to allocating the first set of communication event resources.

13. A method implemented by an application executed on a device, the method comprising the operations comprising:
allocating a first set of communication event resources for receiving communication event data at a computer device;
allocating a second set of communication event resources for transmitting communication event data from the computer device; and
reallocating resources from one of said sets to the other of said sets in dependence on an indication of the relative importance of the received communication event data compared to the transmitted communication event data.

14. A method according to claim 13 comprising the operations of:
receiving at the computer device said indication from at least one remote user equipment, said indication being an instruction to transfer resources from one of said sets to the other of said sets.

15. A method according to claim 13, comprising the operations of:
determining at the computer device an indication of the relative importance of the received communication event data compared to the transmitted communication event data;
wherein the reallocating is performed in dependence on the determined indication.

16. A method according to claim 15, wherein the indication is determined in dependence on at least one of: an explicit indication provided by a user of the computer device; and an implicit indication from the computer device.

17. A method according to claim 13, comprising the operation of transferring information between the computer device and at least one remote user equipment.

18. A method according to claim 13, wherein the reallocating operation is configured to improve a quality of at least one stream of communication event data relative to other streams of communication event data, the streams of communication event data being either transmitted by or received by the computer device.

19. A method according to claim 13, comprising the operation of prioritising one of video and audio communication event data relative to each other and to reallocate resources from one of said sets to the other said sets so as to improve the prioritised communication event data.

20. A computer program product, the computer program product being embodied on a computer readable medium and configured so as when executed on a processor of a device comprising a network interface to:
allocate a first set of communication event resources for receiving communication event data at the computer device;
allocate a second set of communication event resources for transmitting communication event data from the computer device; and
reallocate resources from one of said sets to the other of said sets in dependence on an indication of the relative importance of the received communication event data compared to the transmitted communication event data.
